(19) United States
(12) Patent Application Publication
(10) Pub. No.: US 2006/0218382 A1
(43) Pub. Date: Sep. 28, 2006

(54) Data processing disorder preventing method

(75) Inventor: Chih-Wei Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/080,864

(22) Filed: Mar. 11, 2005

(51) Int. Cl. G06F 9/44

(52) U.S. Cl. 712/225

(57) ABSTRACT

A data processing disorder preventing method applicable to a program having a plurality of processing procedures is proposed. The plurality of processing procedures serve to frequently process the same data block within a storage unit of a system, wherein the data block can only be processed by one processing procedure at a time. First, a status value is set in each of the data blocks of the storage unit. Then, each of the data blocks is successively processed by the plurality of processing procedures according to the status value of each of the data blocks. By such arrangement, the present invention is capable of successively processing the data in each block using the plurality of processing procedures according to the status value set in each data block. Therefore, each data block can be prevented from being simultaneously processed by other processing procedures without requiring the prior-art complex processing procedures, and the processing order of the plurality of processing procedures can be automatically enforced, so as to avoid disorder of the data processing.

### FIELD OF THE INVENTION

The present invention relates to a data processing disorder preventing method, and more particularly, to a data processing disorder preventing method applicable to a program having a plurality of processing procedures. The plurality of processing procedures serve to frequently process the same data block within a storage unit of a system, wherein the data block can only be processed by one processing procedure at a time.

### BACKGROUND OF THE INVENTION

General computer systems such as desktop computers, notebook computers, servers or workstations all comprise a plurality of complex programs. These programs further comprise a plurality of processing procedures, such that each data block in a storage unit (such as a memory device) of the system can be processed by the processing procedure to perform data accesses (reads or writes) of the data block.

However, when processing is performed using the plurality of processing procedures, frequently, the same data block of the storage unit needs to be processed. However, the data block can only be processed by one processing procedure at a time in order to maintain the integrity of the data. Presently, processing procedures of a program are provided with a plurality of locking mechanisms (semaphore flags, sentries, or other software devices) to prevent the same data block from being processed by more than one of processing procedures at a time.

FIG. 1 is a flowchart showing a single processing procedure according to the prior-art. First of all, in Step S10, it is determined whether a data block is presently being processed by any other processing procedures (including another instance of the same procedure). If the needed data block is in use, Step S10 is repeated to periodically pole the data block until it becomes available. If the needed data block is available (not in use), Step S11 is performed to first lock the data block (via one of the foregoing locking mechanisms) prior to performing Step S12 to process data in the data block, so as to prevent concurrent access to the data block by any competing procedures while the data block is being accessed in order to maintain data integrity. After processing is complete, Step S13 is performed to unlock the data block, such that the data block is made available for processing to other processing procedures.

In addition to the above case of basic access locking, sometimes it is necessary to enforce a particular order of access by processing procedures processing data within the same data block. As such, it is not enough to simply determine whether a data block is available for processing (not in use), but rather an additional check must be made to see if any required “pre-processing” by other processing procedures has already been accomplished before processing the data block by the current processing procedure. FIG. 2(A) and FIG. 2(B) are flowcharts illustrating the case where multiple processing procedures must access the same data block in a particular order according to the prior-art. Using the simplest situation, two processing procedures shown in the figure serve as an example to provide description. FIG. 2(A) refers to a processing procedure A and FIG. 2(B) refers to a processing procedure B. Further, an interactive relationship exists between these two procedures, as processing procedure A has to be performed before performing processing procedure B.

Referring to FIG. 2(A), first, in Step S20, processing procedure A determines whether a needed data block is being accessed by any other processing procedures. If the data block is in use by another procedure, Step S20 is repeated to periodically poll the block until it becomes available. If, however, the block is available (not in use), Step S21 is performed to lock the data block (via the foregoing locking mechanism) prior to performing Step S22 to process the data block. After completing the processing, Step S23 is performed to set a flag memory location to the value of “A.” Subsequently, Step S24 is performed to unlock the data block, such that the data block can be processed by processing procedure B.

Referring to FIG. 2(B), in the meantime, processing procedure B continuously repeats Step S30 to determine whether the data block is being processed by any other processing procedures (such as procedure A) until the processing has been completed. After the data block has been unlocked, Step S31 is performed to lock the data block (via the foregoing locking mechanism) prior to performing Step S32 to determine whether the flag is set to “A” (in other words, processing procedure B can only be performed after processing by processing procedure A has been completed). This is the so-called “interactive relationship.” If the flag is set to “A” (i.e. processing procedure A has been completed), Step S33 is performed to process the data in the data block. Afterwards, Step S34 is performed to set the flag to “B” prior to performing Step S35 to unlock the data block, such that the data block can be processed by other processing procedures. On the contrary, in Step S32, if the flag is not set to “A,” the data block is not ready for processing by procedure B at this time, and Step S36 is performed to unlock the data block and return it to the available state. Subsequently, Step S30 is repeated to re-determine whether the data block is being processed by any other processing procedures. This sequence of checking whether the data block is available and then checking whether the required processing of the data block by procedure A has been accomplished will continue until both the data block has become available and this required “pre-processing” has been completed, whereupon procedure B will then process the data block as described above.

Accordingly, the processing procedures need to be provided with a locking mechanism to prevent the data block from being simultaneously processed by any other processing procedures. Additionally, if interactive relationships exist between two or more processing procedures, a plurality of locking mechanisms is required in order to maintain an order of processing as required by the interactive relationship. Additionally, the processing procedures need to be further provided with an order determining mechanism (such as examining the flag of the foregoing example) to prevent the data from being processed out of order, such that data integrity can be maintained. The foregoing method, however, complicates the processing procedures and might disturb the order if not implemented correctly, thereby causing disorder and errant results. Moreover, the design of the program might also be complicated, and thus it lacks practicability, particularly when the method is scaled to a plurality of processing procedures.

The problem to be solved here, therefore, is to provide a data processing disorder preventing method, by which the same data block can be prevented from being simultaneously processed by other processing procedures which is also capable of automatically enforcing an order of processing access without requiring the complex prior-art processing procedures.

### SUMMARY OF THE INVENTION

In light of the above prior-art drawbacks, a primary objective of the present invention is to provide a data processing disorder preventing method, by which the same data block can be prevented from being simultaneously processed by other processing procedures.

Another objective of the present invention is to provide a data processing disorder preventing method, by which processing order of a plurality of processing procedures can be automatically enforced.

In accordance with the above and other objectives, the present invention proposes a data processing disorder preventing method applicable to a program having a plurality of processing procedures. The plurality of processing procedures serve to frequently process the same data block within a storage unit of a system, and the data block can only be processed by one processing procedure at a time. First of all, a status value is set in each of the data blocks within the storage unit. Then, each of the data blocks is successively processed by the plurality of processing procedures according to the status value of each of the data blocks.

In comparison to the complex processing procedures implemented using the prior-art technique, the present invention is capable of successively processing any data block using a plurality of processing procedures according to a status value set in the data block. Therefore, each data block can be prevented from being simultaneously processed by other processing procedures without requiring the complex prior-art processing procedures, and the processing order of the plurality of processing procedures can be automatically enforced.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart showing a single processing procedure according to the prior-art;

FIG. 2(A) and FIG. 2(B) are flowcharts showing two processing procedures accessing the same data block one-at-a-time and in a specified order according to the prior-art;

FIG. 3 is a flowchart showing the basic steps of one embodiment of a data processing disorder preventing method according to the present invention;

FIG. 4 is a flowchart showing the steps of a program which employs the data processing disorder preventing method of one embodiment proposed in the present invention;

FIG. 5(A), FIG. 5(B), FIG. 5(C), FIG. 5(D) and FIG. 5(E) are block diagrams showing that a data block is processed by a data processing disorder preventing method according to a preferred embodiment of the present invention;

FIG. 6(A) and FIG. 6(B) are flowcharts showing the steps of a data processing disorder preventing method according to a preferred embodiment of the present invention.

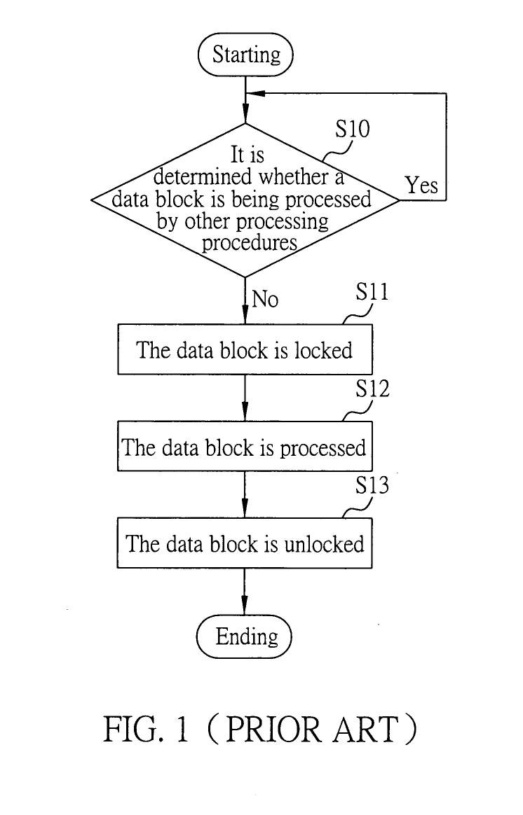

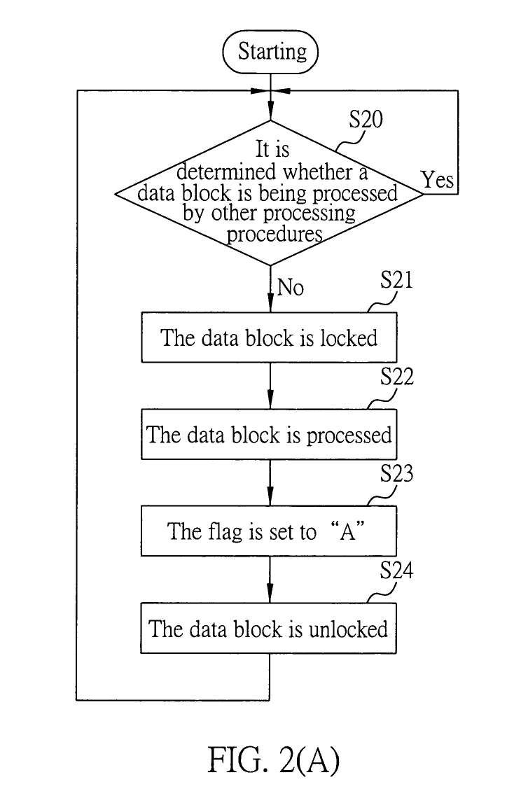

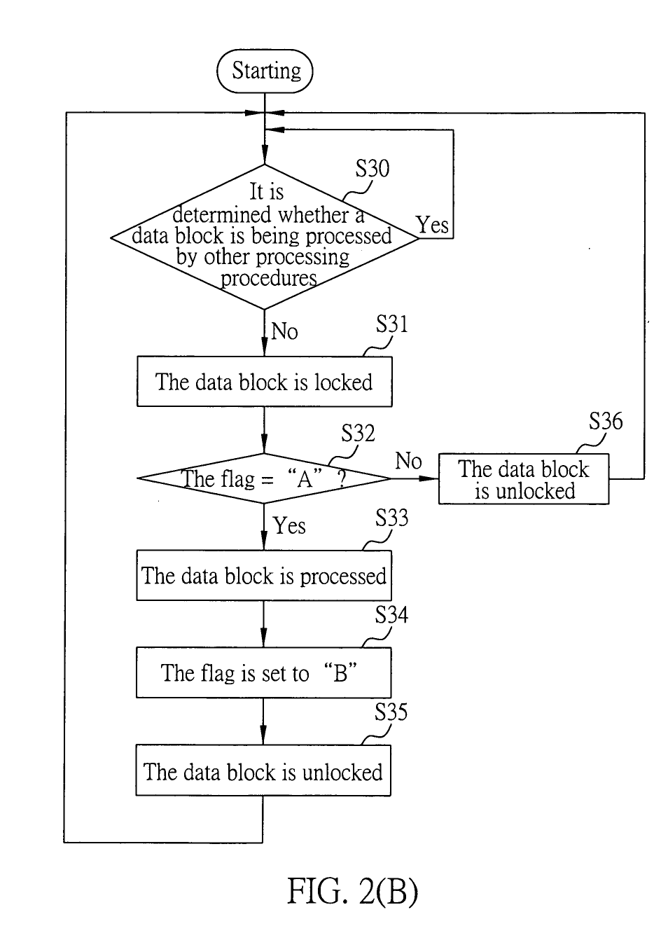

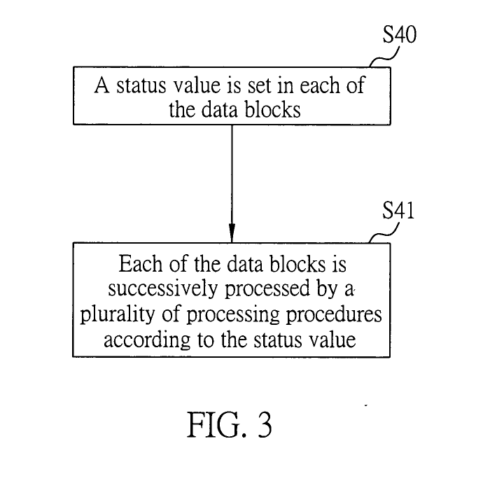

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

FIG. 3 is a flowchart showing the basic steps of a data processing disorder preventing method according to the present invention. Note that the drawings are simplified, and only the components related to the present invention are shown in the drawings.

Referring to FIG. 3, the data processing disorder preventing method proposed in the present invention is applicable to a program having a plurality of processing procedures. The plurality of processing procedures serve to frequently process the same data block within a storage unit of a system, and the data block can only be processed by one processing procedure at a time.

First, in Step S40, a status value is set in each of the data blocks. A status value is set in each of the data blocks within the storage unit of the system, and the status value can be modified according to the processing progress of the plurality of processing procedures. Subsequently, Step S41 is performed.

In Step S41, each of the data blocks is successively processed by the plurality of processing procedures according to the status value. Referring to the foregoing status value set in each of the data blocks, Step S41 is performed so that each of the data blocks is successively processed by the plurality of processing procedures which individually are able to process such data blocks. Thus, each of the data blocks is only processed by one processing procedure per time. Further, after the processing has been completed by a processing procedure, the next processing procedure can be successively performed.

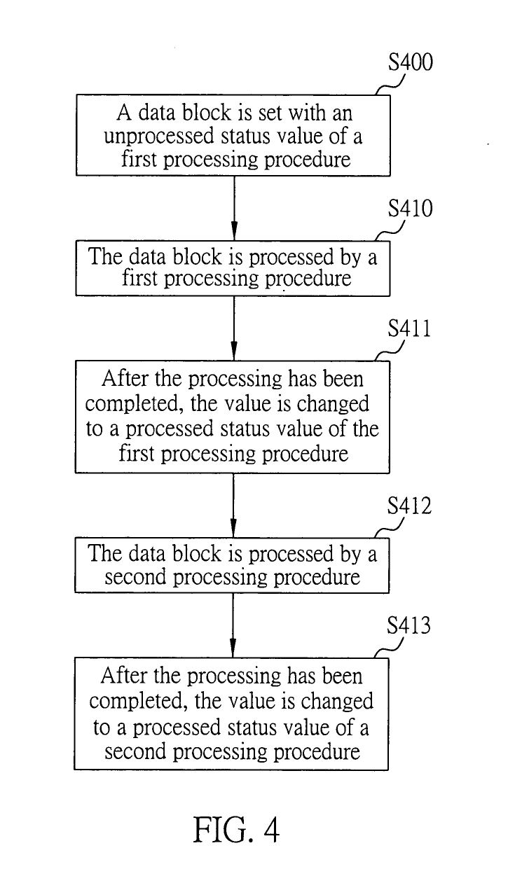

FIG. 4 is a flowchart showing steps of a program having a plurality of processing procedures which employs a data processing disorder preventing method proposed in the present invention. In the figure, a first processing procedure and a second processing procedure processing the same data block are used to illustrate an example of the foregoing plurality of processing procedures. In the illustration, the first processing procedure and the second processing procedure frequently process the same data block within a storage unit of a system, and the data block can only be processed by either the first processing procedure or the second processing procedure at a time. Furthermore, in this example, the program needs to perform the first processing procedure prior to performing the second processing procedure. The steps of an embodiment for accomplishing this control are shown in the following:

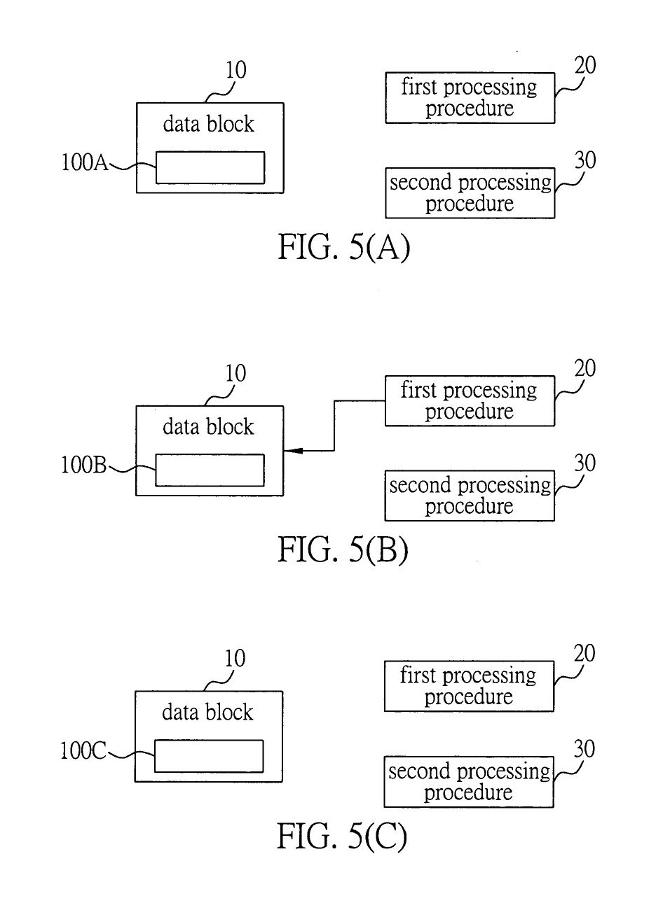

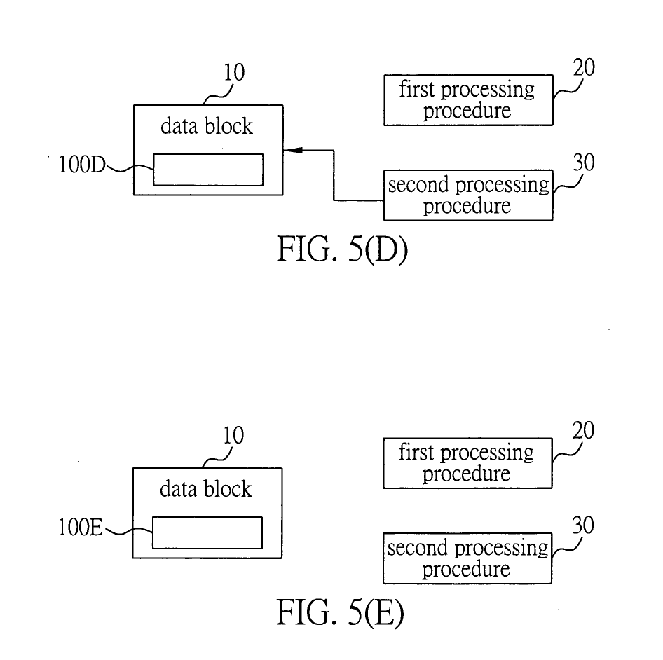

In Step S400, a data block is set with an unprocessed status value representing readiness for processing by the first processing procedure. Referring to FIG. 5(A), such a step involves presetting an unprocessed status value of 100A in a data block 10 within the storage unit, such that evaluation can be performed by subsequent steps. Then, Step S410 is performed.

In Step S410, the data block is processed by the first processing procedure. Referring to FIG. 5(B), the data block 10 is processed by a first processing procedure 20 according to the unprocessed status value of 100A preset in the data block 10 corresponding to the first processing procedure. Moreover, the unprocessed status value of 100A corresponding to the first processing procedure in the data block 10 is altered to a processing status value of 100B. Subsequently, Step S411 is performed.

In Step S411, after the processing has been completed, the value is altered to a processed status value for the first processing procedure. Referring to FIG. 5(C), after the data block 10 has been processed by the foregoing first processing procedure 20, in Step S411, the processing status value of 100B of the data block 10 is altered to a processed status value of 100C. Then, Step S412 is performed.

In Step S412, the data block is processed by the second processing procedure. Referring to FIG. 5(D), the data block 10 is processed by a second processing procedure 30 according to the processed status value of 100C indicating completed processing of the first processing procedure for the data block 10. Further, the processed status value 100C for the first completed processing procedure for the data block 10 is altered to a processing status value of 100D for the second processing procedure prior to performing Step S413.

In Step S413, after the processing has been completed, the value is altered to a processed status value of the second processing procedure. Referring to FIG. 5(E), after the data block 10 has been processed by the foregoing second processing procedure 30, in Step S413, the processing status value of 100D for the second processing procedure of the data block 10 is altered to a processed status value of 100E for the second processing procedure. In this embodiment, the presence of the first processing procedure and the second processing procedure serve as a description for the present invention. During practical application, if there are additional processing procedures, the processing procedures are performed according to the foregoing steps. Accordingly, referring to the method proposed in the present invention, the same data block is not simultaneously processed by a plurality of processing procedures, and the data block can be processed successively in an order.

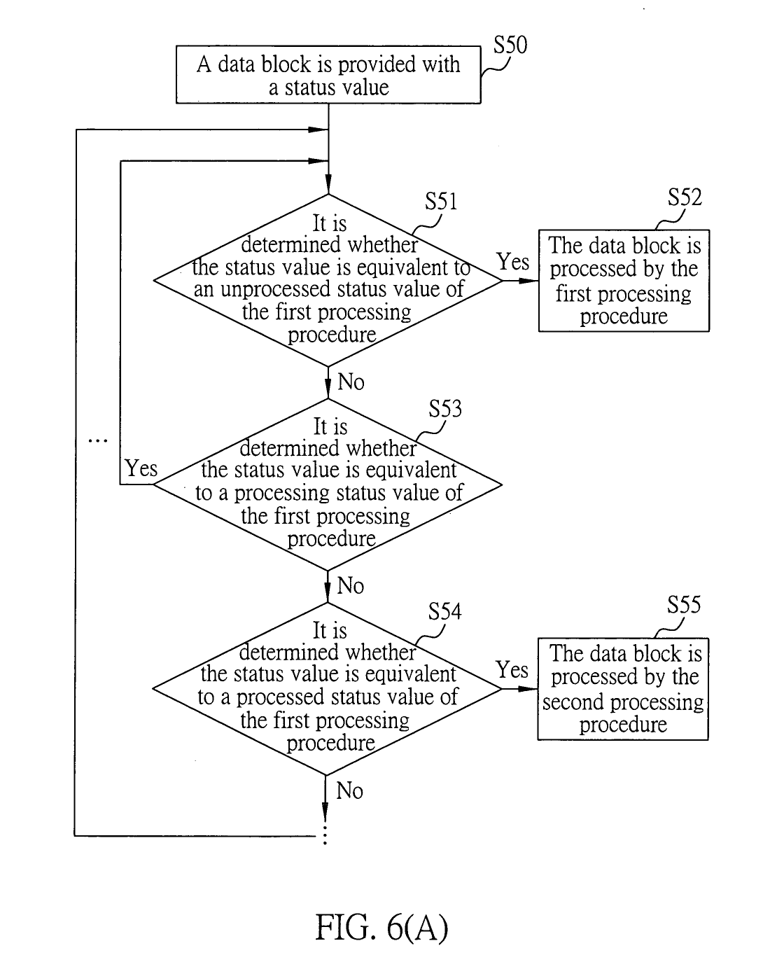

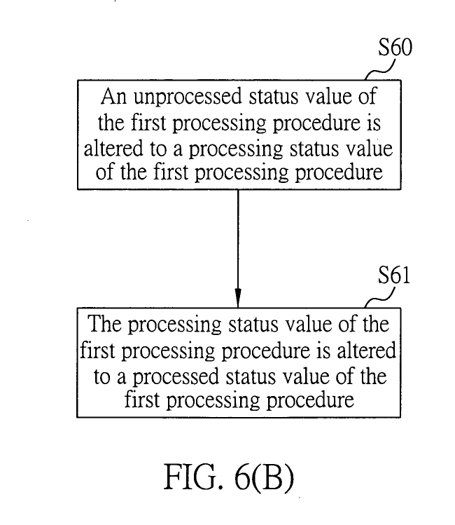

Furthermore, FIG. 6(A) and FIG. 6(B) are flowcharts showing the steps of a data processing disorder preventing method according to a preferred embodiment of the present invention. The steps only serve to provide a demonstrative description, and thus the number of processing procedures can be modified depending on practical requirements. Referring to FIG. 6(A), first, in step S50, a data block is provided with a status value prior to performing Step S51. Such step is the same as what has been described previously and thus will not be further described.

In Step S51, it is determined whether the status value is equivalent to the unprocessed status value for the first processing procedure. More specifically, it is determined whether the status value of the foregoing data block matches the unprocessed status value of the first processing procedure. Step S52 is performed if the status value matches the unprocessed status value, whereas Step S53 is performed if the two do not match.

In Step S52, the data block is processed by the first processing procedure. As previously described, the data block is firstly processed by the first processing procedure in this step. Referring to FIG. 6(B) which shows the steps of performing the first processing procedure, the unprocessed status value for the first processing procedure is altered to a processing status value for the first processing procedure when the data block is processed by the first processing procedure (as shown in Step S60 in FIG. 6(B)).

In Step S53, it is determined whether the status value is equivalent to the processing status value of the first processing procedure. More specifically, it is determined whether the status value of the foregoing data block matches the processing status value for the first processing procedure. Step S51 is repeated for re-evaluation if the result turns out to be yes. If the result turns out to be no, referring to FIG. 6(B), the processing status value of the first processing procedure is altered to a processed status value for the first processing procedure when the processing of the data block has been completed by the first processing procedure (as shown in Step S61 in FIG. 6(B)). Thus, the status value of the data block is no longer the processing status value of the first processing procedure. Subsequently, Step S54 shown in FIG. 6(A) is performed.

In Step S54, it is determined whether the status value is equivalent to the processed status value of the first processing procedure. More specifically, it is determined whether the status value of the foregoing data block matches the processed status value for the first processing procedure. Step S55 is performed if the status value matches the processed status value, whereas Step S53 is repeated to continuously pole the status value of the data block which is altered by the subsequent procedures if the result turns out to be no. The steps are similar to what has been described previously and thus will not be further described.

In Step S55, the data block is processed by the second processing procedure. This step processes the data block using the second processing procedure after the data block has been processed by the first processing procedure. The steps of performing the second processing procedure are similar to those for performing the first processing procedure. The status value of the data block is altered according to the progress of processing the data block, such that subsequent steps can be performed based on the steps shown in FIG. 6(A). These two processing procedures usually differ in terms of the processing done on the data in the data block (such as the calculations performed) during practical application, but such processing does not affect the access control method of the present invention and thus will not be further described. Therefore, the present invention is capable of successively processing the data block using each of the processing procedures that needs to process the data block, so as to simplify the complex prior-art processing procedures.

Accordingly, the present invention is characterized in that the data block can be processed successively using a plurality of processing procedures according to a status value set in the data block. Therefore, the data block can be prevented from being simultaneously processed by other processing procedures without requiring the complex prior-art processing procedures, and the processing order of the plurality of processing procedures can be automatically enforced, so as to prevent disorder of the data processing.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A data processing disorder preventing method applicable to a program having a plurality of processing procedures, wherein, the plurality of processing procedures serve to frequently process the same data block within a storage unit of a system, and the data block can only be processed by one processing procedure at a time, the method comprising steps of:
setting a status value in each of the data blocks of the storage unit, such that the status value can be altered according to the processing progress of the plurality of processing procedures; and
processing each of the data blocks successively by the plurality of processing procedures according to the status value of each of the data blocks.

2. The data processing disorder preventing method of claim 1, wherein the status values are initially set up according to a first processing procedure of the plurality of processing procedures that need to process the data block.

3. A data processing disorder preventing method applicable to a program having a first processing procedure and a second processing procedure, wherein, the first processing procedure and the second processing procedure serve to frequently process the same data block within a storage unit of a system, and the data block can only be processed by either the first processing procedure or the second processing procedure at a time, in which the order of performing the program is performing the first processing procedure prior to performing the second processing procedure, the method comprising steps of:
(1) setting an unprocessed status value of the first processing procedure in the data block of the storage unit prior to performing step (2);
(2) processing the data block by the first processing procedure according to the unprocessed status value of the first processing procedure of the data block prior to performing step (3);
(3) altering the unprocessed status value of the first processing procedure to a processed status value of the first processing procedure according to the progress of the data block processed by the first processing procedure, such that step (4) can be performed after the status value has been altered to a processed status value of the first processing procedure;
(4) processing the data block by the second processing procedure according to the processed status value of the first processing procedure prior to performing step (5);
(5) altering the processed status value of the first processing procedure of the data block according to progress of the data block processed by the second processing procedure.

4. The data processing disorder preventing method of claim 3, wherein, the unprocessed status value of the first processing procedure of the data block is altered to a processing status value of the first processing procedure when the data block is processed by the first processing procedure.

5. The data processing disorder preventing method of claim 3, wherein, the processing status value of the first processing procedure of the data block is altered to the processed status value of the first processing procedure when processing of the data block has been completed by the first processing procedure.

6. The data processing disorder preventing method of claim 3, wherein, the processed status value of the first processing procedure of the data block is altered to a processing status value of the second processing procedure when the data block is processed by the second processing procedure.

7. The data processing disorder preventing method of claim 3, wherein, the processing status value of the second processing procedure of the data block is altered to a processed status value of the second processing procedure when processing of the data block has been completed by the second processing procedure.
